(19) United States
(12) Patent Application Publication
(10) Pub. No.: US 2012/0085365 A1
(43) Pub. Date: Apr. 12, 2012

(54) DISPOSABLE ORAL CARE DEVICE

(76) Inventors: Diane R. Cielo, Punxsutawney, PA (US); Kevin K. Cielo, Punxsutawney, PA (US)

(21) Appl. No.: 12/899,314

(22) Filed: Oct. 6, 2010

(51) Int. Cl. A61C 15/04

(52) U.S. Cl. 132/323

(57) ABSTRACT

An oral care device comprises a body, at least one tooth cleaning device and a mirrored or reflective surface. In one illustrative arrangement, the oral care device includes two tooth cleaning devices at opposite ends of the body and the mirrored or reflective surface is disposed on the body in between the tooth cleaning devices. In another illustrative arrangement, the oral care device includes a tooth cleaning device at one end of the body and the mirrored or reflective surface is disposed on the opposite end of the body. The mirrored or reflective surface may be on an enlarged section of the body and further may be substantially planar or convex. The tooth cleaning device or devices enable a user to clean her teeth and the region between her teeth. The mirrored or reflective surface enables the user to inspect her teeth before, during, and/or after cleaning her teeth with the tooth cleaning device or devices, which in turn, enables the user to better clean her teeth.

### FIELD OF THE INVENTION

The disclosure generally relates to oral care devices. More specifically, the disclosure relates to portable and disposable oral care devices to assist a user in dislodging food that may become lodged between his or her teeth.

### BACKGROUND

During meals, many eaters will get food lodged between their teeth. Based on the type of foods being eaten and/or the spacing between teeth of the eater, getting food lodged between teeth can happen quite frequently. When food becomes lodged between teeth, it can be embarrassing for the eater, especially in certain settings such as in business and formal settings. Additionally and/or alternatively, when food becomes lodged between teeth, it can be uncomfortable to the eater.

Toothpicks have been used for centuries as devices to remove to food that gets lodged between the teeth of the user. Toothpicks have primarily been comprised of generally elongated processed pieces of wood with pointed ends. Toothpicks have also been made of molded plastic. Toothpicks are still generally commonplace as many restaurants include toothpicks at their exits for departing guests.

Dental floss has also been used to clean plaque form between a user's teeth and to remove food lodged between teeth. More recently, disposable devices with a small piece of floss have been used to dislodge food particles in the crevices between teeth. This type of disposable oral care device and toothpicks are convenient to use because they are small and light-weight. However, these oral care devices also have drawbacks. An alternative and/or improved oral care device is therefore desirable.

### BRIEF SUMMARY

A first aspect of the disclosure provides an oral care device having a first and second tooth cleaning devices and a mirrored surface disposed between the first and second tooth cleaning devices enabling the user to inspect his teeth in the mirrored surface.

A second aspect of the disclosure provides an oral care device having a body. The body includes a tooth cleaning device disposed at one end and a mirrored surface disposed at the opposite end of the body enabling the user to inspect his teeth in the mirrored surface.

A third aspect of the disclosure provides an oral care device having a body. The body includes tooth cleaning means coupled to the body for enabling a user to inspect his teeth and reflection means for enabling a user to inspect his teeth. The tooth cleaning means can include one of the arrangements disclosed herein for enabling a user to clean his teeth and equivalents thereof as defined by paragraph 6 of Section 112 of the U.S. patent laws. The reflection means can include one of the arrangements disclosed herein for providing a mirrored-type reflection enabling a user to inspect his teeth and equivalents thereof as defined by paragraph 6 of Section 112 of the U.S. patent laws.

It is to be understood that the foregoing descriptions present illustrative arrangements, features, and embodiments, and are not restrictive of the disclosure unless otherwise noted. The accompanying drawings, which form part of the specification, also illustrate illustrative arrangements, features, and embodiments, and are not restrictive of the disclosure. Together, the descriptions and drawings serve to explain principles, arrangements, features, and embodiments of the disclosure.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates a side view of an illustrative oral care device having a first and second tooth cleaning devices and a mirrored surface disposed between;

FIG. 2 illustrates a side view of an illustrative oral care device having a first and second tooth cleaning devices and a mirrored surface disposed between according to an alternative embodiment;

FIG. 3 illustrates a side view of an illustrative oral care device having a first and second tooth cleaning devices and a mirrored surface disposed between according to another alternative embodiment;

FIG. 4 illustrates a side view of an illustrative oral care device a tooth cleaning device disposed at one end and a mirrored surface disposed at the opposite end;

FIG. 5 illustrates a side view of an illustrative oral care device a tooth cleaning device disposed at one end and a mirrored surface disposed at the opposite end, according to an alternative embodiment; and

FIG. 6 illustrates a side view of an illustrative oral care device a tooth cleaning device disposed at one end and a mirrored surface disposed at the opposite end, according to another alternative embodiment.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

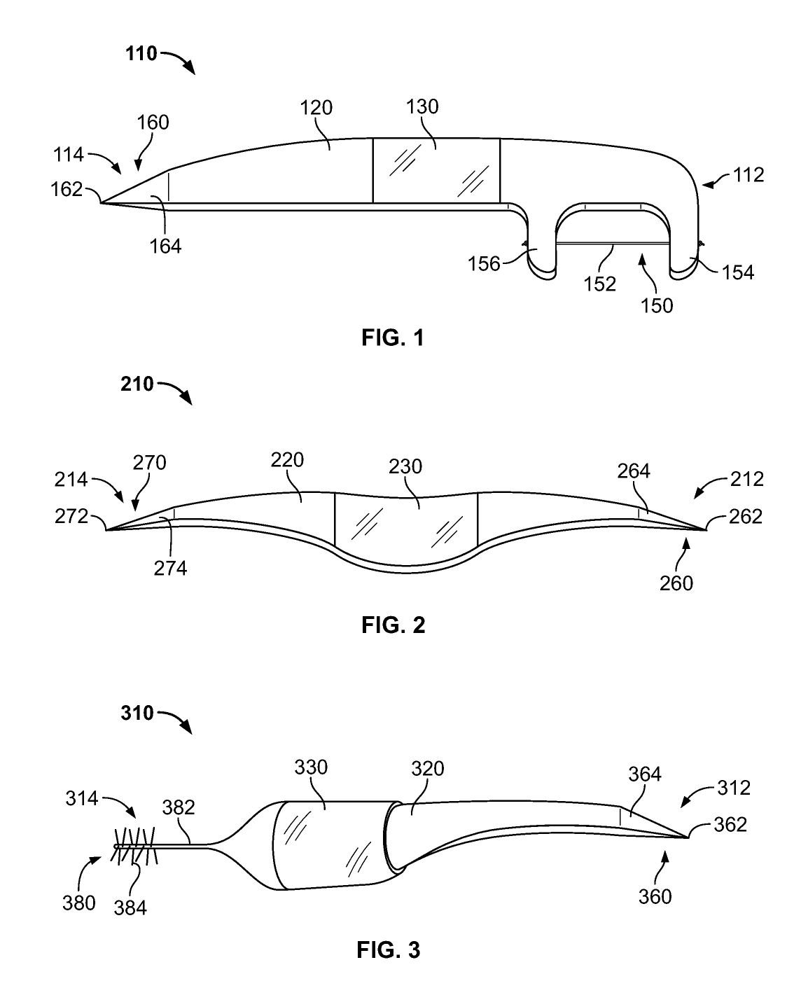

FIGS. 1-6 depict illustrative embodiments containing features of disclosure. The oral care devices in all the embodiments contain at least one reflective surface and at least one tooth cleaning device for the removal of unwanted food from on or in-between the teeth of the user. The reflective surface provides a reflection that the user can gaze into to check the regions on and between his or her teeth. The mirrored surface is a helpful tool in conjunction with the use of the tooth cleaning device or tooth cleaning devices on the oral care device to assist the user to check to see whether there are any foreign bodies on or in-between his teeth and remove them if necessary.

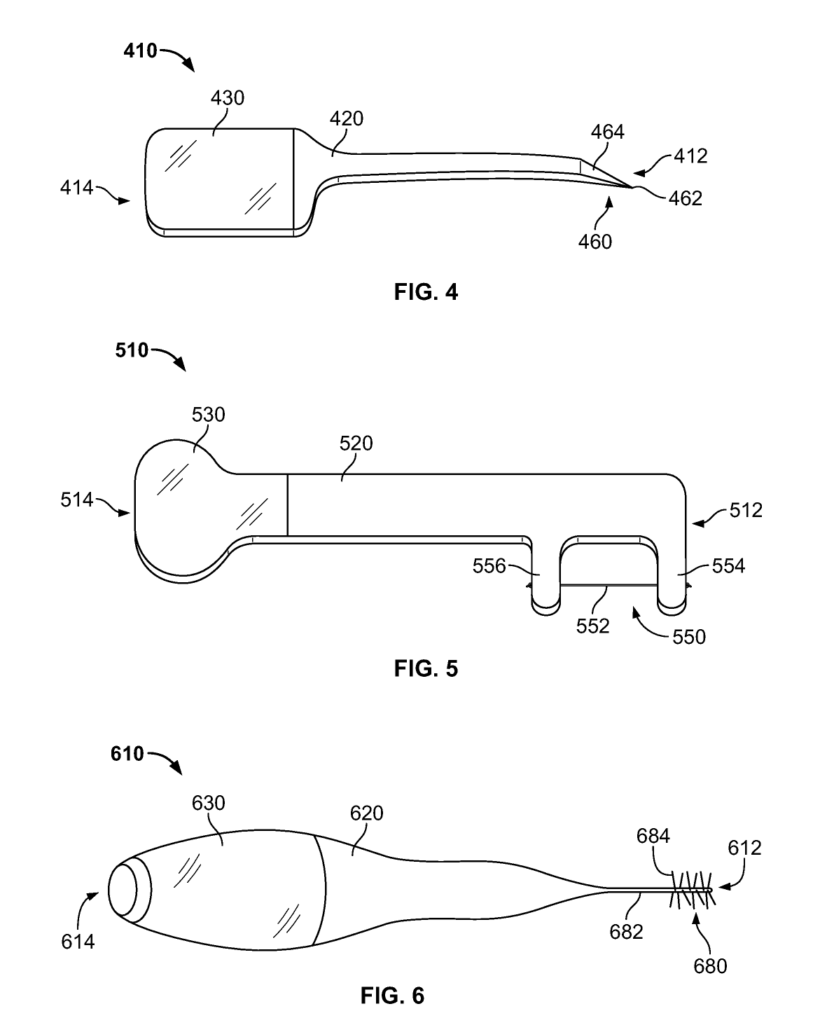

In the illustrative embodiments of FIGS. 1-3, the oral care device includes two tooth cleaning devices with a reflective surface on the body in-between the tooth cleaning devices. In the embodiments of FIGS. 4-6, the oral care device includes a single tooth cleaning device with a reflective surface on the body at the end opposite the tooth cleaning device. Additionally, as will be clear from the description below, the reflective surface can be substantially flat as shown in embodiments of FIGS. 1, 2, 4, and 5. Alternatively, the reflective surface can be contoured, e.g., convex, as shown in embodiments of FIGS. 3 and 6.

The tooth cleaning device or devices used in the embodiments can be any desirable personal cleaning tool designed to enable the user to clean between his teeth. One illustrative tooth cleaning device is an elongated exposed string or filament (e.g., dental floss) anchored on opposing end as shown in the embodiments of FIGS. 1 and 5. Another illustrative tooth cleaning device is a thin elongated rod with micro-bristles radiating therefrom as shown in the embodiments of FIGS. 3 and 6. Another illustrative tooth cleaning device is a tapered or thin elongated pick as shown in the embodiments of FIGS. 1-4 and 6. It is recognized that alternative tooth cleaning devices may be used in lieu of the tooth cleaning devices depicted in the illustrative embodiments.

With respect to the depicted embodiments, FIG. 1 depicts an illustrative oral care device 110 comprising an elongated body 120 having two longitudinal ends 112 and 114. A mirrored-surface 130 is disposed on the body 120 between the two longitudinal ends 112 and 114. The oral care device 110 may have a tooth cleaning device disposed on one or both of the longitudinal ends 112, 114. In the illustrative arrangement of the embodiment of FIG. 1, a tooth cleaning device is located at each longitudinal end 112, 114. At one longitudinal end 112, a floss-type tooth cleaning device 150 is provided in the form of an elongated exposed floss strand 152 anchored at both ends to projections 154 and 156 from the body. The floss-type tooth cleaning device 150 is may be generally U-shaped as shown. It is recognized that any strand-line material suitable for flossing, such as a string or a filament, may be used as a floss strand 152. The floss strand 152 is anchored to first and second projections 154 and 156 in any suitable manner. In one arrangement, the floss strand 152 many be routed through a hole (not shown) in each the projections 152 and 154 and knotted on the outer sides of the projections 152 and 154. Alternatively, and based on the material of the floss strand 152, the floss strand 152 may be anchored to the projections 154 and 156 as part of the molding process. In the depicted embodiments, first and second projections extend generally perpendicularly with respect to the longitudinal axis of the body 120. However, alternative configurations may be used.

At the other longitudinal end 114 of the oral care device 110, a pick-type tooth cleaning device 160 is provided in the form of a tapered section 164 having an exposed pick end 162. The tapered section 164 may take any suitable configuration including the configurations depicted herein.

In the depicted embodiment of FIG. 1, the reflective surface 130 is provided on the central region of the body 120 between the tooth cleaning devices 150 and 160. In the embodiment of FIG. 1, this central region of the body is substantially flat. The reflective surface 130 is also substantially flat (i.e., planar) to correspond to the shape of the body where the mirrored surface is located. The reflective surface 130 can be applied to one face of the body 120 and may optionally be applied to the opposite face (not shown) of the body 120.

FIG. 2 depicts an alternative illustrative embodiment of the oral care device 210. Oral care device 210 includes an elongated body 220 having two longitudinal ends 212 and 214. A mirrored-surface 230 is disposed on the body 220 between the two longitudinal ends 212 and 214. The mirrored surface 230 may be planar and positioned in the center region of the body 220. However, it may alternatively be curved in a manner shown in the other depicted embodiments. The oral care device 210 may have a tooth cleaning device disposed on one or both of the longitudinal ends 212, 214. In the illustrative arrangement of the embodiment of FIG. 2, a tooth cleaning device is located at each longitudinal end 212, 214.

At one longitudinal end 212 of the oral care device 210, a pick-type tooth cleaning device 260 is provided in the form of a tapered section 264 having an exposed pick end 262. The tapered section 264 may take any suitable configuration including the configurations depicted herein. A pick-type tooth cleaning device 270 is provided on the opposite longitudinal end 214 of the oral care device 210 in the form of a tapered section 274 having an exposed pick end 272.

FIG. 3 depicts an alternative illustrative embodiment of the oral care device 310. The oral care device 310 includes an elongated body 320 having two longitudinal ends 312 and 314. A mirrored-surface 330 is disposed on the body 320 between the two longitudinal ends 312 and 314. The mirrored surface 230 may be curved and positioned in the center region of the body 320. However, it may alternatively be substantially planar in a manner shown in the other depicted embodiments. The oral care device 310 may have a tooth cleaning device disposed on one or both of the longitudinal ends 312, 314. In the illustrative arrangement of the embodiment of FIG. 2, a tooth cleaning device is located at each longitudinal end 312, 314.

At one longitudinal end 312 of the oral care device 310, a pick-type tooth cleaning device 360 is provided in the form of a tapered section 364 having an exposed pick end 362. The tapered section 364 may take any suitable configuration including the configurations depicted herein.

A micro-bristle-type tooth cleaning device 380 is provided on the opposite longitudinal end 314 of the oral care device 310. The micro-bristle-type tooth cleaning device 380 includes is a thin elongated rod 382 extending from the body 320. The thin elongated rod 382 is preferably flexible. A plurality of micro-bristles 384 radiate outward from the elongated rod 382. In one embodiment, the micro-bristles 384 are substantially perpendicularly arranged with respect to the elongated rod 382. In one use of the micro-bristle-type tooth cleaning device 380, the user can insert the elongated rod 382 in the space between adjacent teeth and then retract it. The micro-bristles 384 serve to clean the adjacent surfaces of the teeth and will typically eject food particles in the location.

FIGS. 4-6 depict illustrative embodiments of the oral care device 410, 510, 610 where a tooth cleaning device is disposed at one longitudinal end the oral care device 410, 510, 610 and a mirrored surface is provided at the opposite end. More specifically and with respect to the individual figures, FIG. 4 depicts an oral care device 410 having an elongated body 420 with two longitudinal ends 412 and 414. A tooth cleaning device is provided at a first longitudinal end 412. In the depicted embodiment of FIG. 4, the tooth cleaning device takes the form of a pick-type tooth cleaning device 460. However, the other depicted and described tooth cleaning devices as used herein are contemplated in lieu of a pick-type tooth cleaning device 460. The pick-type tooth cleaning device 460 includes a tapered section 464 having an exposed pick end 462. The tapered section 464 may take any suitable configuration including the configurations depicted herein.

A mirrored-surface 430 is disposed on the body 420 on the longitudinal end 414 opposite the tooth cleaning device 460. The body 420 preferably includes an enlarged region at the opposing longitudinal end 414 to the tooth cleaning device 460. In illustrative embodiments, the mirrored surface 430 is applied to all or at least a majority of the enlarged planar region on at least one side of the body 420. The enlarged region and the mirrored surface 430 may be either substantially planar as depicted in FIGS. 4 and 5 or curved as is depicted in FIG. 6. If the enlarged region is planar, the mirrored surface 430 may be included on one or both sides of the body 420. The enlarged region of the body also aids in the gripping and manipulation of the oral care device 410 by the user.

FIG. 5 depicts an alternative illustrative embodiment of an oral care device 510 having an elongated body 520 with two longitudinal ends 512 and 514. A tooth cleaning device is provided at a first longitudinal end 512. In the depicted embodiment of FIG. 5, the tooth cleaning device takes the form of a floss-type tooth cleaning device 550. However, the other depicted and described tooth cleaning devices as used herein are contemplated in lieu of a floss-type tooth cleaning device 550. The floss-type tooth cleaning device 550 can take the form of the floss-type tooth cleaning device as described with respect to FIG. 1 and alternatives and variants described with respect to the floss-type tooth cleaning device FIG. 1 are contemplated with respect to this embodiment. For example, the floss-type cleaning device 550 may be in the form of an elongated exposed floss strand 552 anchored at both ends to projections 554 and 556 from the body.

A mirrored-surface 530 is disposed on the body 520 on the longitudinal end 514 opposite the tooth cleaning device 460. The body 520 preferably includes an enlarged region at the opposing longitudinal end 514 to the tooth cleaning device 550. In illustrative embodiments, the mirrored surface 530 is applied to all or at least a majority of the enlarged planar region on one or both sides of the body 520. The enlarged region and the mirrored surface 530 may be either substantially planar as depicted in FIGS. 4 and 5 or curved as is depicted in FIG. 6. If the enlarged region is planar, the mirrored surface 530 may be included on one or both sides of the body 520. The enlarged region of the body also aids in the gripping and manipulation of the oral care device 510 by the user.

FIG. 6 depicts an alternative illustrative embodiment of an oral care device 610 having an elongated body 620 with two longitudinal ends 612 and 614. A tooth cleaning device is provided at a first longitudinal end 612. In the depicted embodiment of FIG. 6, the tooth cleaning device takes the form of a micro-bristle-type tooth cleaning device 580. However, the other depicted and described tooth cleaning devices as used herein are contemplated in lieu of the micro-bristle-type tooth cleaning device 580. The micro-bristle-type tooth cleaning device 680 can take the form of the floss-type tooth cleaning device as described with respect to FIG. 3 and alternatives and variants described with respect to the floss-type tooth cleaning device FIG. 1 are contemplated with respect to this embodiment. For example, the micro-bristle-type cleaning device 680 may be in the form of a flexible thin elongated rod 682 extending from the body 620 with a plurality of micro-bristles 684 radiating outward from the elongated rod 682.

A mirrored-surface 630 is disposed on the body 620 on the longitudinal end 614 opposite the tooth cleaning device 680. The body 620 preferably includes an enlarged region at the opposing longitudinal end 614 to the tooth cleaning device 680. In the depicted embodiment, the enlarged region and the mirrored surface 630 is curved and convex. In lieu of this arrangement, the enlarged region and the mirrored surface may be substantially planar as depicted in FIGS. 4 and 5. In one illustrative arrangement, the mirrored surface 630 may be applied to 60 degrees or more of the curved enlarged region around the body. However, in other arrangements, the mirrored surface may be applied to 90 degrees or more, 180 degrees or more, 360 degrees, or between 180 and 60 degrees of the curved enlarged region around the body. One benefit of the contemplated arrangement with the mirrored surface applied to between 180 and 60 degrees of the curved enlarged region is that it provides visual queues for the user so that the non-mirrored surface should be used for gripping the oral care device and the mirrored surface 630 for viewing, and decreases the likelihood of the user dirtying the mirrored surface 630. The curved convex enlarged region of the body also aids in the gripping and manipulation of the oral care device 610 by the user.

In the illustrative embodiments as described herein, the body 120, 220, 320, 420, 530, 620 may be formed by a plastic and may be molded using a suitable polymer. According to the illustrative embodiments, the length of the oral care device 110, 210, 310, 410, 510, 610 is between 1.5 and 4 inches. However, alternative arrangements with a longer or shorter length are also contemplated.

The region of the body to which the mirrored surface is applied may be enlarged. By that, it is meant that the enlarged region includes a noticeable widening in the body along its length. The enlarged region of the body containing the mirrored surface provide an increased viewing area for the user to inspect his teeth and also aids in the gripping and manipulation of the oral care device by the user.

Additionally, the mirrored-surface 130, 230, 330, 430, 530, 630 may be made of any suitable material known in the art for creating a reflective surface. For example, a reflective metallic coating on a polymer substrate may be used. Other methods and material may also be utilized to form the mirrored-surface such as polished metal or a silicon-based reflective coating. The mirrored-surface may be formed from a separate element, such a flat piece of sheet material, adhered or otherwise affixed to the body. Alternatively, the mirrored-surface may be formed as a coating or treatment directly to the body. As shown in the illustrative embodiments, the mirrored-surface 130 takes the general shape of the external surface of the body 120 at the location where it is applied. Accordingly, the mirrored surface may be flat where the underlying surface is flat or contoured and taking the form of the underlying surface when the underlying surface is countered.

In use, the oral care device as described herein provides a small and disposable solution to help the user removal of unwanted food from on or in-between the her teeth. Each oral care device includes one or more tooth cleaning devices. The user can use a tooth cleaning device in a manner as known in the art. The oral care devices also include one reflective surface. The user can view her teeth by using the reflecting to view the reflection of her teeth and assist her as she cleans her teeth. This can be particularly useful as in many situations the user may not be near a mirror to view her teeth or access to another mirrored surface may be less convenient. Thus, having the mirrored surface and the tooth cleaning device on the oral care device not only aids in better oral care, it also can assist the user in removing debris that is typically undesirable in social and business situations.

Because the oral care device 110, 210, 310, 410, 510, 610 is small, it can be carried in his or her pocket, purse, wallet, or any other convenient storage locale. The oral care device 110, 210, 310, 410, 510, 610 may also be offered by restaurants to their customers. If desired, the oral care devices may be wrapped and sealed, either individually or in multiple units, to make them more sanitary should a commercial establishment, like a restaurant, desire to offer them.

Additionally, as used herein, the term “between teeth floss-pick” is hereby defined as one of the following: (a) an elongated exposed string or filament anchored on opposing sides, (b) a thin flexible elongated rod with micro-bristles radiating therefrom, and (c) a tapered or thin elongated pick—each configured to be inserted between adjacent teeth to remove particulate matter therein.

While the invention has been described with respect to specific examples including presently preferred modes of carrying out the invention, those skilled in the art will appreciate that there are numerous variations and permutations of the above described systems and techniques. For example, it is specifically contemplated that any of the depicted and described tooth cleaning devices may be used in lieu of a tooth cleaning devices in any of the depicted illustrative embodiments. Similarly, it is specifically contemplated that any of the depicted and described body configurations and mirrored surfaces may be used in lieu of the body configurations and mirrored surfaces in any of the depicted illustrative embodiments. Applicant further reserves the right to supplement the figures to include additional embodiments disclosed in the written specification. Thus, the spirit and scope of the invention should be construed broadly as set forth in the appended claims.

What is claimed is:

1. An oral care device comprising:
a first tooth cleaning device;
a second tooth cleaning device; and
a mirrored surface disposed between the first tooth cleaning device and the second tooth cleaning device enabling the user to inspect his teeth in the mirrored surface.

2. The oral care device according to claim 1, wherein the first tooth cleaning device is a first between teeth floss-pick; and the second tooth cleaning device is a second between teeth floss-pick.

3. The oral care device according to claim 2, wherein the first between teeth floss-pick is an elongated pick.

4. The oral care device according to claim 3, wherein the second between teeth floss-pick is an elongated pick.

5. The oral care device according to claim 3, wherein the second between teeth floss-pick includes a first member extending substantially perpendicularly with respect to an elongated axis of the oral care device, a second member extending substantially perpendicularly with respect to the elongated axis; and a strand of dental floss held in tension between the first and second member.

6. The oral care device according to claim 2, wherein the first between teeth floss-pick includes a piece of floss supported at opposing ends.

7. The oral care device according to claim 2, wherein the first between teeth floss-pick includes a thin flexible elongated rod and a plurality of micro-bristles radiating from the thin flexible elongated rod.

8. The oral care device according to claim 2, further comprising a body made from a plastic and wherein the mirrored surface is applied to the body, and wherein the oral care device is between 1.5 and 4 inches.

9. The oral care device according to claim 8, wherein the body includes an enlarged section and the mirrored surface is planar and is applied to the enlarged section of the body.

10. The oral care device according to claim 8, wherein the mirrored surface is convex.

11. An oral care device comprising:
a body;
a tooth cleaning device disposed at a first end of the body; and
a mirrored surface disposed at an opposite side of the body enabling the user to inspect his teeth in the mirrored surface.

12. The oral care device according to claim 11, wherein the tooth cleaning device is an elongated pick.

13. The oral care device according to claim 11, wherein the tooth cleaning device is a piece of floss supported at opposing ends.

14. The oral care device according to claim 11, wherein the tooth cleaning device includes a thin flexible elongated rod and a plurality of micro-bristles radiating from the thin flexible elongated rod.

15. The oral care device according to claim 11, wherein the body includes a planar section and the mirrored surface is applied to the planar section of the body.

16. The oral care device according to claim 11, wherein the body is made from a plastic and includes a convex surface, and the mirrored surface is applied to the convex surface of the body.

17. The oral care device according to claim 11, wherein the body includes an enlarged region relative to the remainder of the body and the mirrored surface is coupled to the enlarged region.

18. An oral care device comprising:
a body;
tooth cleaning means coupled to the body for enabling a user to inspect his teeth; and
reflection means for enabling a user to inspect his teeth.

19. The oral care device of claim 18, wherein the tooth cleaning means is a first tooth cleaning means and the oral care device further comprises a second tooth cleaning means coupled to the body, coupled to the body at an opposite end from the first tooth cleaning means.

20. The oral care device of claim 18, wherein tooth cleaning means is coupled to a first end of the body and the reflection means is disposed at an opposite end of the body from the tooth cleaning means.
